(19) United States
(12) Patent Application Publication
(10) Pub. No.: US 2015/0269637 A1
(43) Pub. Date: Sep. 24, 2015

(54) METHOD AND APPARATUS FOR PROVIDING ADVERTISEMENTS ON WEB SITES

(71) Applicant: Gustavo Garcia, Perth Amboy, NJ (US)

(72) Inventor: Gustavo Garcia, Perth Amboy, NJ (US)

(21) Appl. No.: 14/217,545

(22) Filed: Mar. 18, 2014

(51) Int. Cl. G06Q 30/02

(52) U.S. Cl. CPC G06Q 30/0277

(57) ABSTRACT

Repeating a following process for one or more iterations, starting with a first iteration where m=1: retrieving an advertisement for an mth member of an advertising service from a computer memory; causing the advertisement for the mth member to be displayed on a web page of a web site of a particular member of the advertising service; and determining if a change indication is received within the web page of the web site, and if the change indication has been received causing the advertisement for the mth member to no longer be displayed on the web page of the web site, and thereafter, if m is not a last member of the advertising service, incrementing m by one, and repeating the process.

### FIELD OF THE INVENTION

This invention relates to improved methods and apparatus concerning providing advertisements on web sites.

### BACKGROUND OF THE INVENTION

There are various devices known for providing advertisements on web sites.

### SUMMARY OF THE INVENTION

One or more embodiments of the present invention provide a method comprising repeating a following process for one or more iterations, starting with a first iteration where m=1: Retrieving an advertisement for an mth member of an advertising service from a computer memory; causing the advertisement for the mth member to be displayed on a web page of a web site of a particular member of the advertising service; and determining if a change indication is received within the web page of the web site, and if the change indication has been received causing the advertisement for the mth member to no longer be displayed on the web page of the web site, and thereafter, if m is not a last member of the advertising service, incrementing m by one, and repeating the process.

The particular member of the advertising service may be an nth member, wherein n=1 for the first iteration; and the process may further include if the change indication has not been received, determining if the nth member is the last member of the advertising service, and if not incrementing n by one and repeating the process.

If the change indication has been received, the method may include determining if the mth member is the last member of the advertising service, and if so, setting m=1, and repeating the process.

The method may further include, prior to the step of repeating the process for one or more iterations, registering a plurality of members for the advertising service in a computer memory. The step of registering the plurality of members for the advertising service in a computer memory may include storing in a computer memory a plurality of advertisements, one for each of the plurality members.

The step of registering the plurality of members for the advertising service in a computer memory may include storing a plurality of sets of data in and associating each set of data with one of the plurality of advertisements in a computer memory, each set of data indentifying a member of the plurality of members.

At least one embodiment of the present invention provides an apparatus including a a server computer processor; and a server computer memory. The server computer processor may be programmed by computer software to repeat the process for one or more iterations, as previously described.

### BRIEF DESCRIPTION OF THE DRAWINGS

FIG. 1 shows block diagram of an apparatus in accordance with an embodiment of the present invention;

FIG. 2 shows a flow chart of a method for use with an embodiment of the present invention; and

FIG. 3 shows another flow chart of a method for use with another embodiment of the present invention.

### DETAILED DESCRIPTION OF THE DRAWINGS

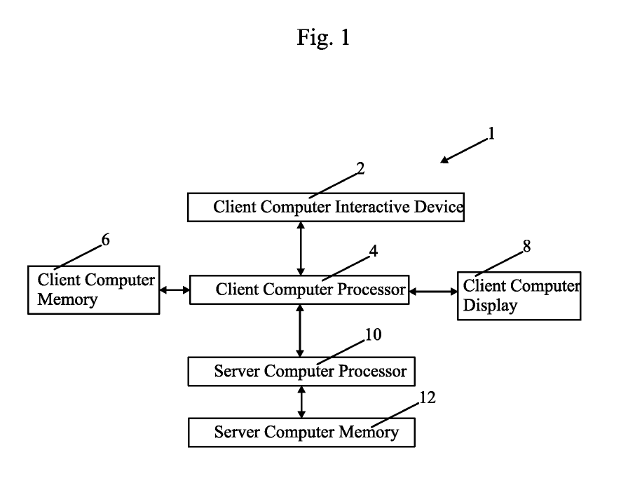

FIG. 1 shows block diagram of an apparatus 1 in accordance with an embodiment of the present invention. The apparatus 1 includes a client computer interactive device 2, a client computer processor 4, a client computer memory 6, a client computer display 8, a server computer processor 10, and a server computer memory 12. The client computer interactive device 2, the client computer memory 6, the client computer display 8, and the server computer processor 10 are in communication with and/or electronically connected to client computer processor 4 by communications links. The communications links may include hard wired, wireless, optics, software communication links, or any known communications links. The server computer processor 10 is in communication with and/or electronically connected to the server computer memory 12 by communications links, which may be include any known communications links. The server computer processor may be programmed by a computer software stored in server computer memory 12 to perform functions as will be described below.

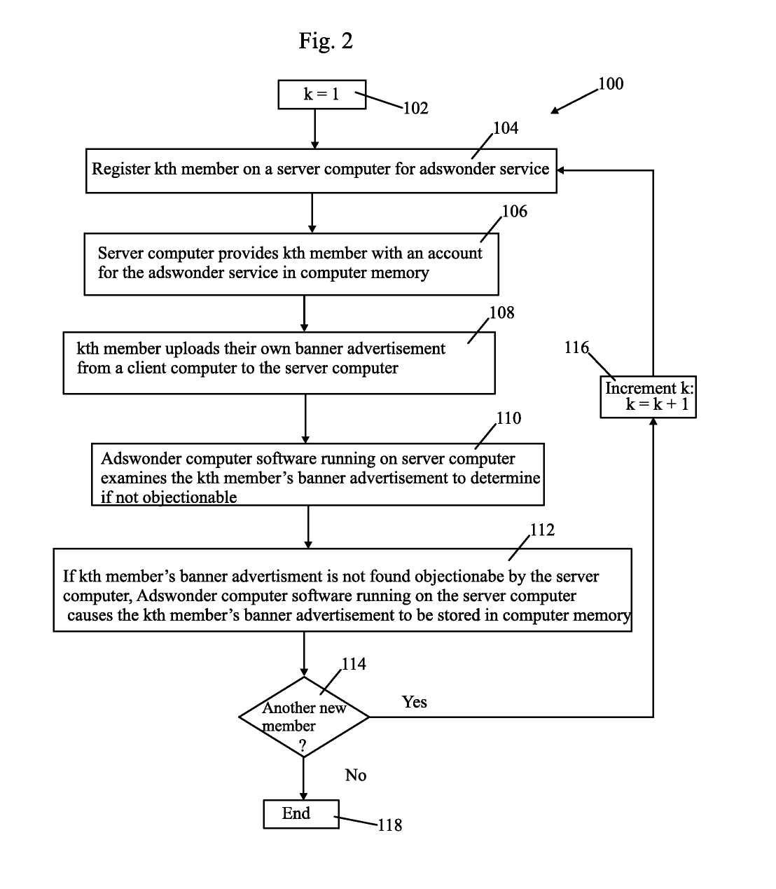

FIG. 2 shows a flow chart 100 of a method for use with an embodiment of the present invention. The flow chart 100 includes step 102 at which an index k is initialized to 1 by the server computer processor 10 in the server computer memory 12. At step 104, the server computer processor 10 is programmed by computer software stored in the server computer memory 12 to register a kth member (for the first pass a first member, for k=1) for what may be called “adswonder service” in accordance with an embodiment of the present invention. The server computer processor 10 may receive data from the client computer processor 4, such as data over the internet which may be used to register the kth member. Typical registration data, such as name, address, password, etc. may be stored in server computer memory 12 by the server computer processor 10. At step 106 the server computer processor 10 may provide the kth member with an account for the “adswonder service” or advertisement service in accordance with an embodiment of the present invention, in the server computer memory 12.

At step 108 the kth member can upload their own banner advertisement or some other advertisement from the client computer processor 4 to the server computer processor 10. At step 110, computer software running on the server computer processor 10 may be programmed to determine if the banner advertisement of the kth member is not objectionable. At step 112 if the kth member's advertisement is not found objectionable by the server computer the server computer processor 10 stores the uploaded advertisement of the kth member in the kth member's account in server computer memory 12.

At step 114, the server computer processor 10 determines whether another new member should be registered. If the answer is yes, the index k is incremented in the server computer memory 12, and the process returns to step 104 for registration of another member (for the second iteration k=2 for the second member, for the third iteration, k=3 for the third member, etc.),If there are no more new members to register then the process ends at step 118. In at least one embodiment, after the first member is registered, the process may begin at step 114, when a new member sends information from a client computer processor 4, or another client computer processor to the server computer processor 10, such as via the internet to register another new member.

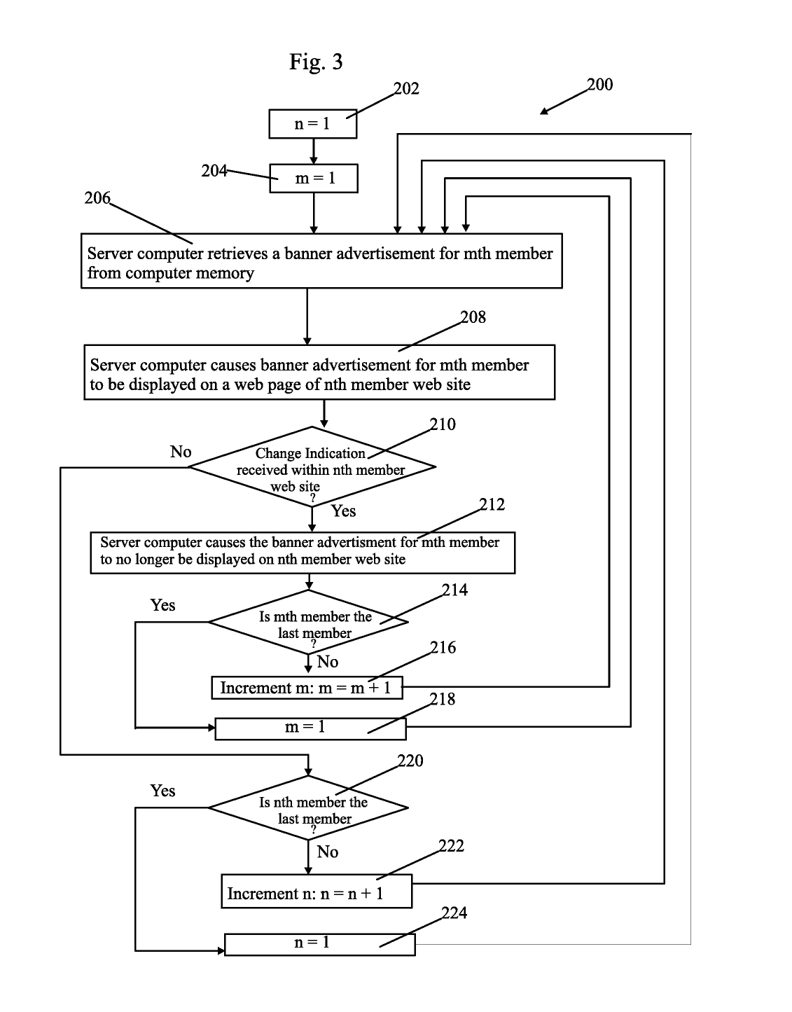

FIG. 3 shows another flow chart 200 of a method for use with another embodiment of the present invention. At step 202, the index n is set to 1. At step 204 the index m is set to 1. At step 206, the server computer processor 10 retrieves a banner advertisement or some other advertisement for the mth member (for the first pass, the first member) from the server computer memory 12. At step 208, the server computer processor 10 causes a banner advertisement for the mth member to be displayed on a web page of an nth member (for the first pass, the first member) web site. The web page may be the home page of the nth member's web site.

At step 210, the server computer processor 10 determines whether a change indication has been received within the nth member's web site page, where the advertisement for the mth member is being displayed. A change indication, might be refreshing of the web page, clicking on a link within the web page to go to another web page, or some other change indication. If a change indication is received, the server computer processor 10 causes the advertisement for the mth member to no longer be displayed on the nth member's web site. At step 214, the server computer processor 10 determines if the mth member is the last member. For example, if the mth member was the first member, than the server computer processor 10 determines if there is a second member registered. If there is another member registered, m is incremented at step 216. For example, from “1” to “2”, to go from the first member to the second member. The process would then loop back to step 206 where the server computer processor 10 would retrieve the advertisement for the mth member (on the second pass the second member) from the server computer memory 12. In this manner, all of the advertisements of all of the registered members are displayed on an nth member's web site, typically in sequence (i.e. not at the same time), by being effectively cycled through.

If a change indication was not received at step 210, the server computer processor 10 determines if the nth member is the last member at step 220. If not, then n is incremented at step 222, (for example from a first member to a second member), and then the process loops back to step 206 with a banner advertisement being retrieved and now being displayed on the next member's web site (for example the second member's web site). In this manner each member's advertisement, such as a banner advertisment, is displayed on all member's web sites.

If the nth member was the last member at step 220, then n is reinitialized to 1 at step 224 and the process again loops back to step 206.

In at least one embodiment, a member of an advertising service in accordance with an embodiment of the present invention, may be required, in one or more embodiments, to paste a code provided by the server computer processor 10 in a web site page of the member of the advertising service. For example, a member may be required to download a code from the server computer processor 10 and paste the code in and on the home page of a web site of the member, and then upload that home page or web page to the server computer processor 10 or some other server computer processor. This code may provide the location in the web page or home page and information needed to display advertisements of members of the advertisement service (typically by cycling through all members advertisements such as by process shown in FIG. 3).

The member advertisements displayed may include links to other web sites.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
repeating the following process for one or more iterations, starting with a first iteration where m=1:
retrieving an advertisement for an mth member of an advertising service from a computer memory;
causing the advertisement for the mth member to be displayed on a web page of a web site of a particular member of the advertising service; and
determining if a change indication is received within the web page of the web site, and if the change indication has been received causing the advertisement for the mth member to no longer be displayed on the web page of the web site, and thereafter, if m is not a last member of the advertising service, incrementing m by one, and repeating the process.

2. The method of claim 1 wherein
the particular member of the advertising service is an nth member, wherein n=1 for the first iteration;
and as part of the process further comprising:
if the change indication has not been received, determining if the nth member is the last member of the advertising service, and if not incrementing n by one and repeating the process.

3. The method of claim 2 further comprising
if the change indication has been received, determining if the mth member is the last member of the advertising service, and if so, setting m=1, and repeating the process.

4. The method of claim 1 further comprising
prior to the step of repeating the process for one or more iterations, registering a plurality of members for the advertising service in a computer memory.

5. The method of claim 4 wherein
the step of registering the plurality of members for the advertising service in a computer memory includes storing in a computer memory a plurality of advertisements, one for each of the plurality members.

6. The method of claim 5 wherein
the step of registering the plurality of members for the advertising service in a computer memory includes storing a plurality of sets of data in and associating each set of data with one of the plurality of advertisements in a computer memory, each set of data indentifying a member of the plurality of members.

7. An apparatus comprising
a server computer processor; and
a server computer memory;
wherein the server computer processor is programmed by computer software to repeat the following process for one or more iterations, starting with a first iteration where m=1:
retrieve an advertisement for an mth member of an advertising service from the server computer memory;
cause the advertisement for the mth member to be displayed on a web page of a web site of a particular member of the advertising service; and
determine if a change indication is received within the web page of the web site, and if the change indication has been received cause the advertisement for the mth member to no longer be displayed on the web page of the web site, and thereafter, if m is not a last member of the advertising service, increment m by one, and repeat the process.

8. The apparatus of claim 7 wherein
the particular member of the advertising service is an nth member, wherein n=1 for the first iteration;
and as part of the process further comprising:
if the change indication has not been received, determine if the nth member is the last member of the advertising service, and if not increment n by one and repeat the process.

9. The apparatus of claim 8 wherein
if the change indication has been received, determine if the mth member is the last member of the advertising service, and if so, set m=1, and repeat the process.

10. The apparatus of claim 7 wherein
the server computer processor is programmed to register a plurality of members for the advertising service in a computer memory, prior to repeating the process for one or more iterations.

11. The apparatus of claim 10 wherein
the server computer processor is programmed to store in a computer memory a plurality of advertisements, one for each of the plurality members, as part of registering the plurality of members for the advertising service in a computer memory.

12. The apparatus of claim 11 wherein
the server computer processor is programmed to store a plurality of sets of data in and associate each set of data with one of the plurality of advertisements in a computer memory, each set of data indentifying a member of the plurality of members, as part of registering the plurality of members for the advertising service in a computer memory.
